(19) United States
(12) Patent Application Publication
(10) Pub. No.: US 2024/0177059 A1
(43) Pub. Date: May 30, 2024

(54) Scalable Pseudo Labelling Process for Classification

(71) Applicant: PayPal, Inc., San Jose, CA (US)

(72) Inventors: Jing Xia, Shanghai (CN); Nandana Murthy, Singapore (SG); Chawannut Prommin, Santa Clara, CA (US); Santosh Addanki, Cupertino, CA (US)

(21) Appl. No.: 18/326,455

(22) Filed: May 31, 2023

(30) Foreign Application Priority Data
Nov. 30, 2022 (WO) PCT/CN2022/135618

(51) Int. Cl. G06N 20/00; G06F 16/28

(52) U.S. Cl. CPC G06N 20/00; G06F 16/285

(57) ABSTRACT

Techniques for generating training datasets for machine learning algorithms are disclosed. An initial labelled dataset may be a noisy dataset with multiple misclassifications in labelling of the data. Human-based annotation and the application of historical data information are implemented to refine labels for a subset of data from the initial labelled dataset. After refinement of the subset of data, data with existing labels is extracted from the initial labelled dataset to add to the refined subset and generate a training dataset. The data that is extracted from the initial labelled dataset is data that is similar to data in the refined subset with the same label as the extracted data. The extraction of data according to similarities in the data is applied to scale the subset of data to a larger dataset while maintaining quality in order to provide a large, high-quality training dataset for the machine learning algorithm.

### PRIORITY CLAIM

The present application claims priority to PCT Appl. No. PCT/CN2022/135618, entitled “SCALABLE PSEUDO LABELLING PROCESS FOR CLASSIFICATION”, filed Nov. 30, 2022, which is incorporated by reference herein in its entirety.

### BACKGROUND

### Technical Field

This disclosure relates generally to software architecture improvements for machine learning, including methods of creating training datasets for training machine learning algorithms, according to various embodiments.

### Description of the Related Art

Many current classification mechanisms focus on techniques that optimize classification results such as Accuracy, F1 score, ROC, AUC. The evaluation (e.g., training) datasets that are needed in order to utilize these techniques, however, may have particular accuracy requirements. Accordingly, creating evaluation datasets suitable for these techniques can be a difficult and time consuming process. For instance, methods for creating datasets such as template-based methods or keyword-based inductive methods are very time consuming.

Additionally, these methods may not be suitable for use in specialized domains. Applicant recognizes that computer system functionality and efficiency can be improved via mechanisms for fast construction of large, diverse, and high quality datasets for training and evaluation of machine learning algorithms.

### BRIEF DESCRIPTION OF THE DRAWINGS

FIG. 1 is a block diagram of a system for generating a training dataset, according to some embodiments.

FIG. 2 is a block diagram of a label refinement module, according to some embodiments.

FIG. 3 is a block diagram of a data selection module, according to some embodiments.

FIG. 4 is a block diagram of a machine learning training module, according to some embodiments.

FIG. 5 is a block diagram of a data selection module implemented on an existing training dataset, according to some embodiments.

FIG. 6 is a flow diagram illustrating a method for generating a training dataset for a machine learning algorithm, according to some embodiments.

FIG. 7 is a flow diagram illustrating a method for updating a training dataset for a machine learning algorithm, according to some embodiments.

FIG. 8 is a block diagram of one embodiment of a computer system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z). In some situations, the context of use of the term “or” may show that it is being used in an exclusive sense, e.g., where “select one of x, y, or z” means that only one of x, y, and z are selected in that example.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION

The present disclosure is directed to various techniques related to the creation of large scale datasets utilized for training and evaluation of machine learning algorithms. One example of an area where large scale datasets for training are useful is classification of text data. Text data may be produced by a wide variety of data sources including chat messages (such as customer service chats), search queries, help center requests, emails, text messaging, web pages, or social media applications. Text data from these different sources may be in a variety of unorganized, freeform formats without any characterization or labelling of the text data. Text data may be especially prevalent in customer service based interactions (such as chat messages, search queries, or help center requests as discussed above). Classification of text data during customer service interactions may be useful to increase efficiency in resolving customer service issues by providing useful insight for customer service agents. In some instances, classification of text data may be implemented to provide automated responses in text-based customer service interactions.

In various instances, intent classification is implemented for text data based interactions. Intent classification may be useful in determining what a customer's goal (e.g., intent) is during a text-based interaction by classifying utterances (e.g., words or phrases) made by the customer. With the implementation of intent classification, a customer may be better served by a customer service agent, leading to a more satisfactory customer experience. In automated interactions, intent classification accuracy is needed in order for the customer to receive reliable service by the “bot” in fulfilling the customer's needs or requests.

Intent classification of text data may include utilization of large numbers of categories. For example, many customer service interactions have intent categories numbering into the hundreds. Training a machine learning algorithm to accurately classify into intent categories at such high numbers requires a large number of training datasets. For instance, there can be large variations in text data between customers (e.g., customers can have very different ways of wording questions or answers). Thus, large training datasets are needed to train machine learning algorithms implementing intent classification to accurately classify intent into these large numbers of categories.

Creating large training datasets for text data may, however, be a time consuming and costly process. For instance, many current techniques for creating training datasets for text data often involves manual annotation of text data (e.g., human-implemented annotation). Manual annotation is typically needed in order to provide accurate labelling of text data for training machine learning algorithms. The use of human annotators in creating large numbers of datasets is, however, expensive (due to labor costs) and not very efficient. Additionally, it is becoming increasingly difficult to find human annotators. It can be especially difficult to find human annotators for industries that have high security protocols because of the handling of sensitive information (such as the financial service industry).

The present disclosure contemplates various techniques for generating training datasets for machine learning algorithms that have large amounts of high-quality labelled training data. While the techniques disclosed herein focus on creating high-quality labelled training datasets for text data, it should be understood that the disclosed techniques are not limited to text data and may be implemented for many additional types of data where large numbers of high-quality labelled training datasets are useful. Additionally, the present disclosure contemplates techniques for updating the training datasets based on additional information or changes in operation of machine learning algorithms (e.g., data drift in the machine learning algorithms).

One embodiment described herein has three broad components: 1) selecting a subset of data from a large, initially labelled dataset, 2) applying annotation to the subset of data to refine labels on the data, and 3) selecting (e.g., extracting) additional data from the large dataset for a training dataset based on similarities between the additional data and data in the annotated subset of data where the additional data selected from the large, initially labelled dataset has existing labels identical to the labels in the annotated subset of data. In certain embodiments, the large, initially labelled dataset includes labelled data with some amount of “noise” in the labels for the data. For instance, the large dataset may be initially labelled using classification techniques that leave noise in the labels (e.g., the initially labelled dataset may have multiple misclassifications in labelling of the data). In some embodiments, a two-tier cleanup algorithm is applied to the subset of data that has been annotated to mitigate inconsistencies and further refine labels on the data in the subset of data. The clustering algorithms may be used to at least somewhat randomly constrain the possible overreaching of the similarity based selection of additional data for the training dataset.

In various embodiments, after annotation of data in the subset that refines the labels in the subset, labels in the annotated subset may be utilized to identify and retrieve additional sets of data from the large, initially labelled dataset for potential utilization in a training dataset. For example, additional (potential) data from the large, initially labelled dataset may be retrieved based on the additional data having existing labels that are identical to labels in the annotated subset. After retrieval of the potential data, measures of similarity between the retrieved data and data in the annotated subset may be determined and assessed to determine portions of the retrieved data to utilize in the training dataset. For instance, portions of the retrieved data that have higher similarity to the data in the annotated subset may be selected for implementation in the training dataset. In some embodiments, the retrieved data may be ranked based on determined similarity values between the retrieved data and data in the annotated subset and retrieved data for adding to the training dataset is then selected based on the rankings. In various embodiments, the retrieved data selected for the training dataset is added to the annotated subset to generate the training dataset. The training dataset, now having both the refined label data from the annotated subset and the additional data extracted based on similarities to the refined label data, is provided to a machine learning algorithm for training of the machine learning algorithm.

In short, the present inventors have recognized the benefit of creating a pipeline that combines the generation of a high-quality annotated dataset with a process that extracts additional data from a large, labelled dataset based on similarities to the annotated dataset to create a training dataset with a large amount of high-quality labelled data. The disclosed pipeline allows large amounts of high-quality labelled training data to be generated in a short amount of time and without the need for large amounts of expensive and time consuming human annotation. Additionally, the disclosed techniques provide a pipeline that can be implemented to quickly add additional high-quality training data to a dataset when additional data becomes available or there is drift (e.g., data drift) in the operation of a machine learning algorithm. Implementation of the disclosed pipeline and its corresponding techniques provides a system for generating large amounts of high-quality training data to improve the operation and accuracy of machine learning algorithms being applied to various types of data. Large, high-quality training datasets may be specifically useful for data types that have large numbers of classification categories such as text data.

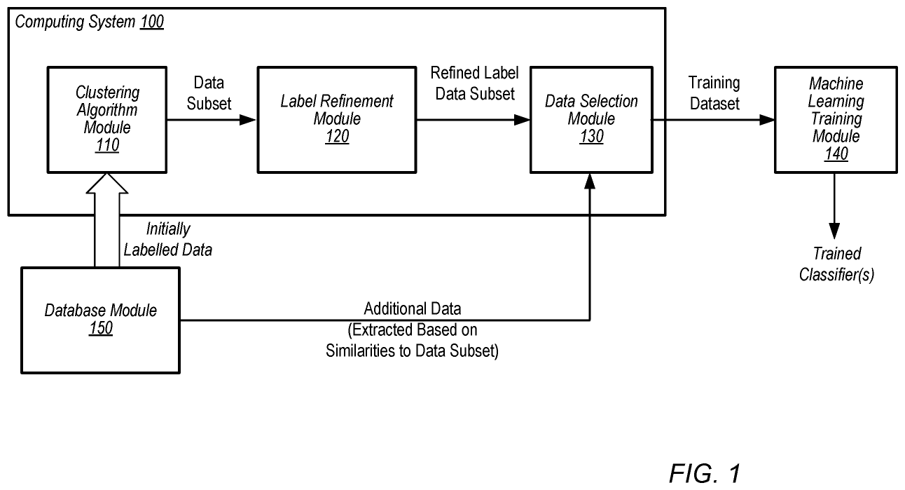

FIG. 1 is a block diagram of a system for generating a training dataset, according to some embodiments. In the illustrated embodiment, computing system 100 includes clustering algorithm module 110, label refinement module 120, and data selection module 130. As used herein, the term “computing system” refers to any computer system having one or more interconnected computing devices. Note that generally, this disclosure may include various examples and discussion of techniques and structures within the context of a “computer system.” Note that all these examples, techniques, and structures are generally applicable to any computing system that provides computer functionality. The various components of computing system 100 (e.g., computing devices) may be interconnected. For instance, the components may be connected via a local area network (LAN). In some embodiments, the components may be connected over a wide-area network (WAN) such as the Internet.

In various embodiments, clustering algorithm module 110 accesses initially labelled data from database module 150. As used herein, “initially labelled data” may be any set of data (such as text data) that is known to have some “noise” in the labelling of data (e.g., some misclassification in the labelling of the data). As described herein, the performance of a machine learning algorithm trained based on “noisy” training data may be reduced due to the errors in labelling. In various embodiments, database module 150 may include any database containing data that has been initially labelled with some noise in some manner. For instance, the data may have been labelled by some type of logic such as a classification algorithm or a rules-based algorithm that likely has some misclassifications in the labelling. Generally speaking, the initially labelled data accessed from database module 150 is data that has been coarsely labelled without refinement to the labels applied to the data. In some embodiments, the data in database module 150 is data labelled in an unsupervised manner. Unsupervised labelling may lead to misclassification of some pieces (e.g., items) of data. In certain embodiments, the data accessed by clustering algorithm module 110 is text data that is initially labelled. Text data may be from sources including, but not limited to, chat messages (e.g., customer service chats), search queries, help center requests, emails, text messaging, web pages, or social media applications. In some embodiments, text data is labelled with utterance or intent labels. Thus, noise in the initially labelled text data may be misclassification of various words or groups of words with incorrect utterance or intent labels.

In certain embodiments, clustering algorithm module 110 applies one or more clustering algorithms to the initially labelled data to select a data subset for label refinement (e.g., refinement by label refinement module 120). Examples of algorithms that may be applied by clustering algorithm module 110 include, but are not limited to, keyword clustering algorithms, randomness clustering algorithms, K-means clustering algorithms, and other unsupervised clustering algorithms. The data subset for label refinement determined by clustering algorithm module 110 is thus a randomized set of data selected without bias.

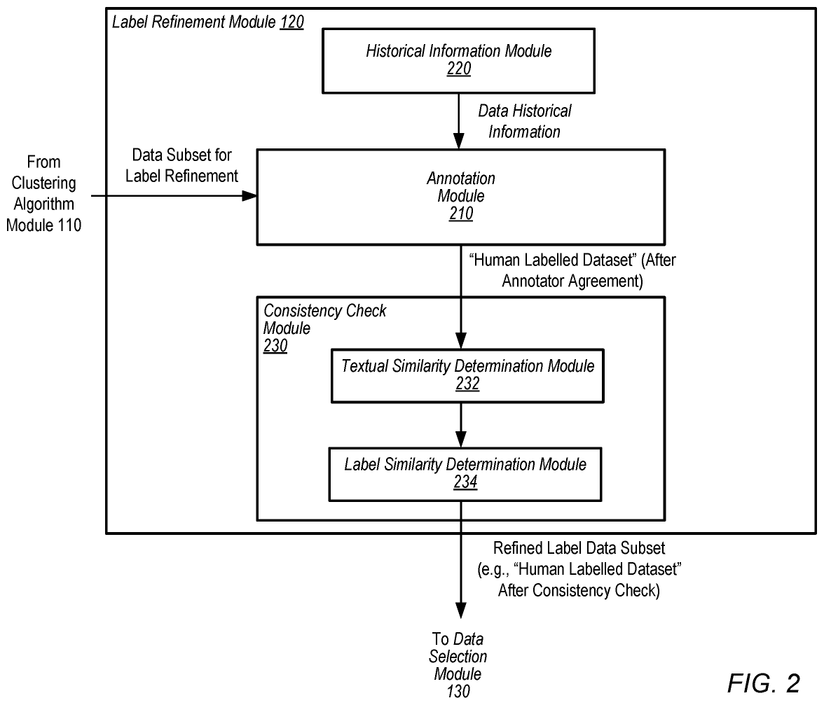

As shown in FIG. 1, the data subset selected by clustering algorithm module 110 is provided to label refinement module 120. In various embodiments, label refinement module 120 implements data annotation and applies historical information to the data subset to refine the labels for the dataset. Refining of the labels for the dataset may include, for example, increasing accuracies of labels applied to data (e.g., text data) in the dataset. FIG. 2 is a block diagram of label refinement module 120, according to some embodiments. In the illustrated embodiment, label refinement module 120 includes annotation module 210, historical information module 220, consistency check module 230, and verification module 240.

In certain embodiments, the data subset for label refinement is annotated in annotation module 210. In various embodiments, data annotation applied by annotation module is human-implemented data annotation. For instance, a human data annotator may process through the subset of data to adjust (e.g., refine) the labels on the data (e.g., text data) according to their knowledge of the classification labels and the data. The annotation process may be reiterated as needed until an annotated data subset agreement is reached (e.g., multiple annotators agree on a label for the data). In various embodiments, the agreement may be an agreement between multiple human annotators. In some embodiments, the agreement may be an agreement between one or more human annotators and one or more machine-based annotators.

In certain embodiments, historical information is implemented in the annotation process. For example, annotation module 210 may access historical information from historical information module 220. Historical information may include, but not be limited to, historical product data or historical product knowledge available for the data. In some embodiments, historical information is human-implemented during the annotation process (e.g., implemented by a human annotator). In other embodiments, historical information is implemented by a machine-based annotator. After annotation agreement is reached, the data subset has been refined to have more accurate labelling on the data than the initially labelled data from which the data subset was obtained. In some instances, the data subset with refined labelling output by annotation module 210 may be referred to as a “human labelled dataset”.

The human labelled dataset output by annotation module 210 includes data (e.g., text data) with labels assigned to the data. Though the labels in the human labelled dataset are largely more accurate than the labels in the initially labelled data, there still may be some mistakes as human annotators can still make mistakes in labelling of data. In certain embodiments, after refinement of the labelling by annotation module 210, a consistency check may be applied to the data subset by consistency check module 230. Application of the consistency check may reduce or mitigate errors from human annotation of the data. The consistency check may be implemented, for example, to clean up labelled data in the human labelled dataset to remove inconsistencies in labelling.

In various embodiments, consistency check module 230 implements a cleanup algorithm to the human labelled dataset to clean up the dataset. The cleanup algorithm may, for instance, include a two-tier assessment of text data in the dataset and labels in the dataset to determine whether text data that is similar is also labelled similarly. In various embodiments, consistency check module 230 includes textual similarity determination module 232 and label similarity determination module 234. Textual similarity determination module 232 may implement a first tier (e.g., first step) of the cleanup algorithm and label similarity determination module 234 may implement a second tier (e.g., second step) of the cleanup algorithm. Accordingly, textual similarity determination module 232 and label similarity determination module 234 may together determine whether there is consistency between text and labels in the dataset.

As an example for the cleanup algorithm implemented by consistency check module 230, a data point (e.g., item of data), “Data_A”, may include text, “TextA”, and have a label, “Label-I”. A first step (e.g., tier) in the cleanup algorithm implemented by textual similarity determination module 232 may be to identify nearest neighbors to Data_A in the dataset based on textual similarity to “TextA”. In the context of this disclosure, nearest neighbors may be determined based on measures of similarity between data points. For instance, various algorithms may be contemplated that determine a measure of similarity between two data points or relative measures of similarity between multiple data points. An example of a measure of similarity between two data points is a similarity value that is a numerical indication of similarity between the two data points (for instance, a number between 0 and 1 with 1 being most similar). An example of relative measures of similarity between multiple data points may be an agnostic ranking (e.g., a ranking of data points by similarity to a specific data point without specific similarity values being determined) or a visual-based display of data points based on similarity (with data points nearest each other being most similar). Various algorithms or other assessment mechanisms may be applied to determine any of these various measures of similarity. While any of these various measures of similarity between data points, as well as other measures of similarity not described herein, may be implemented, the present disclosure discusses the utilization of similarity values for determining measure of similarity between data points. It should be understood that various mechanisms associated with the use of similarity values can be applied to other measures of similarity. For instance, mechanisms associated with the ranking of similarity based on similarity values may be applied to agnostic rankings of similarity.

As described herein, a similarity value may be a numerical indication of the similarity between two data points. In various embodiments, a similarity value between two data points may be determined by a similarity algorithm or a plurality of similarity algorithms. Similarity algorithms may, for example, apply rules or categorize data according to similarities in data to determine numerical representations of similarity (e.g., similarity values). In certain embodiments, one or more similarity algorithms are applied to data points in a set of data to determine textual similarity values for the data points. Textual similarity values are numerical indications of the similarity between text associated with two data points. TABLE I provides an example of textual similarity values (with 0 being no similarity and 1 being exactly similar) calculated between text “TextA” in data point Data_A and text in eight additional data points (Data_XA, Data_XB, Data_XC, Data_XD, Data_XE, Data_XF, Data_XG, Data_XH).

TABLE I

| Data Point | Textual Similarity Value to Data_A |
|---|---|
| Data_XA | 0.854 |
| Data_XB | 0.732 |
| Data_XC | 0.134 |
| Data_XD | 0.903 |
| Data_XE | 0.455 |
| Data_XF | 0.689 |
| Data_XG | 0.555 |
| Data_XH | 0.711 |

For the example, a first predetermined ranking threshold “k1” may be set to determine a number of nearest neighbors to Data_A to select based on ranking of similarity. Alternatively, a threshold could be set as a similarity numerical value (e.g., a minimum absolute value of similarity) or some other measure of similarity. In this instance, when k1-6, then the 6 nearest neighbors to “Data_A” based on the textual similarity values shown in TABLE I may be determined as Data_XA, Data_XB, Data_XD, Data_XF, Data_XG, and Data_XH. Thus, Data_XA, Data_XB, Data_XD, Data_XF, Data_XG, and Data_XH are the 6 nearest neighbors to Data_A based on their ranking satisfying the ranking threshold k1.

Once the nearest neighbors based on textual similarity are determined by textual similarity determination module 232, label similarity determination module 234 may implement a second step (e.g. tier) that determines whether a selected number of nearest neighbors have the same label. For instance, a second predetermined threshold “k2” may be set as a minimum number of nearest neighbors having the same label needed in order to retain a data point in the dataset. As example, when k2=2, then at least two nearest neighbors need to have the same label as Data_A for Data_A to be retained in the dataset. Thus, at least two of Data_XA, Data_XB, Data_XD, Data_XF. Data_XG, and Data_XH should have the label “Label-I” for Data_A to be retained in the dataset. If less than two of the nearest neighbors have the label “Label-I”, then Data_A may be removed from the dataset (e.g., removed from the human labelled dataset) as Data_A has been determined to be inconsistent with other data in the dataset based on the applied thresholds.

In various embodiments, the predetermined thresholds (e.g., k1 and k2) may be varied to vary the amount of data retained in the human labelled dataset. For example, the higher the value set for k1, the more data that is maintained in the human labelled dataset while the higher the value set for k2, the less data that is maintained in the human labelled dataset. Adjustment of the thresholds may also be made to vary the quality of data maintained in the dataset (e.g., how consistent the data needs to be). For example, k1 can be set lower or k2 can be set higher to require higher consistency in the data in order to maintain data in the human labelled dataset.

As shown in FIG. 2, consistency check module 230 may output the human labelled dataset (after the consistency check) as the refined label data subset. The refined label data subset output by consistency check module 230 is a dataset that has more accurate labels than the initially labelled data provided to label refinement module 120. The accuracy of the labels in the refined label data subset output by consistency check module 230 is increased by the combination of human annotation (with application of historical information) by annotation module 210 and removal of inconsistencies by consistency check module 230. Accordingly, the refined label data subset output by consistency check module 230 may be considered a refined and accurate dataset suitable for training or evaluation of a high performance machine learning algorithm.

In various embodiments, all or a portion of the refined label data subset output by consistency check module 230 is provided to data selection module 130 for generation of a training dataset, as shown in FIG. 1. For example, in some embodiments, the refined label data subset output by consistency check module 230 is provided as a whole set of data to data selection module 130. In various embodiments, however, only a portion of the refined label data subset output by consistency check module 230 is provided to data selection module 130. For instance, in certain embodiments, the refined label data subset output by consistency check module 230 is divided into a training portion and an evaluation portion with the training portion being provided to data selection module 130 and the evaluation portion being utilized for later evaluation (e.g., testing) of a machine learning algorithm trained by a training dataset based on the training portion. In some embodiments, the division between the training portion and the evaluation portion may be determined by a threshold. For example, a threshold may determine that a selected percentage of the refined label data subset is utilized as the evaluation portion with the remainder being utilized as the training portion. The threshold may be adjusted as needed (for instance, to provide a certain size evaluation portion). Dividing the refined label data subset at this point ensures that the evaluation portion includes data with refined labels (e.g., human labelled data), which is typically preferred for performance evaluation (e.g., testing) of machine learning algorithms.

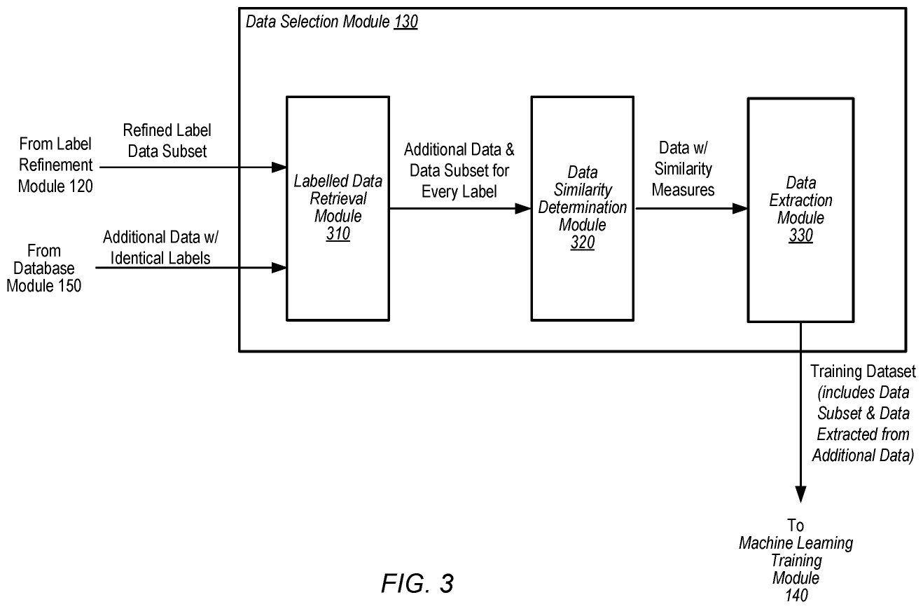

FIG. 3 is a block diagram of data selection module 130, according to some embodiments. In the illustrated embodiment, data selection module 130 includes labelled data retrieval module 310, data similarity determination module 320, and data extraction module 330. In various embodiments, labelled data retrieval module 310 receives the refined label data subset from label refinement module 120 and accesses (e.g., retrieves) additional data from database module 150 based on the refined labels. For example, labelled data retrieval module 310 may receive the refined label data subset and identify the labels found in the refined label data subset. From the identification of the labels found in the refined label data subset, labelled data retrieval module 310 may then access (e.g., retrieve) additional data having the same (e.g., identical) labels from database module 150. Thus, labelled data retrieval module 310 retrieves an additional set of data for a given label found in the refined label data subset based on the data in the additional set having the same given label.

In certain embodiments, labelled data retrieval module 310 retrieves additional data from database module 150 for every label found in the refined label data subset. Accordingly, cach label from the refined label data subset now has its own associated set of data that includes two subsets of data—a first subset of data that includes data from the refined label data subset (e.g., the human labelled dataset) and a second subset of data that includes the additional data retrieved from database module 150. Additionally, since the additional data is retrieved according to a given label found in the refined label data subset, the data in the second subset of data is already labelled with the same given label as the corresponding data in the first subset of data.

In some contemplated embodiments, labelled data retrieval module 310 may retrieve additional data from database module 150 for only a portion of the labels in the refined label data subset. For instance, data may not be retrieved for labels identified as having some minimum predetermined amount of data already existing in the refined label data subset. Accordingly, additional data may be retrieved for only the labels implemented in the retrieval process. Each label implemented in the retrieval process still, however, gets its own associated set of data that includes the two subsets of data.

In certain embodiments, the additional data retrieved by labelled data retrieval module 310 includes all of the data with identical labels available in database module 150. In some embodiments, the additional data retrieved by labelled data retrieval module 310 may include only a portion of the data with identical labels available in database module 150. For instance, only a portion of the data with identical labels available may be accessed if a limit is placed on the amount of data to be added to a training dataset or if there are other limits placed on data processing by system 100.

After labelled data retrieval module 310 retrieves the additional data based on identical labels, the retrieved additional data along with the refined label data subset is provided to data similarity determination module 320. As described above, the retrieved additional data and the refined label data subset includes data for each label implemented in the retrieval process (which can be all the labels found in the refined label data subset or a portion of the labels found). Thus, the data provided to data similarity determination module 320 includes a set of data for each label implemented in the retrieval process that includes the two subsets of data derived from the refined label data subset and the retrieved additional data.

In certain embodiments, data similarity determination module 320 determines, for each set of data associated with each label implemented in the retrieval of additional data, measures of similarity between data (e.g., data points or items of data) in the retrieved data (e.g., the second subset) and data in the refined label data subset (e.g., the first subset). As described above, measures of similarity may be used to determine nearest neighbors based on similarity. In the instances of text data, measures of similarity may be used to determined nearest neighbors based on textual similarity between data points.

In certain embodiments, data similarity determination module 320 determines similarity values between data in the retrieved data (e.g., the second subset) and data in the refined label data subset (e.g., the first subset) to assess measures of similarity between the data. As described above, similarity values may be a numerical indicator of similarity between two data points determined by various algorithms. In some embodiments, similarity values determined between data in the retrieved data and data in the refined label data subset are implemented to determine a ranking of similarity between the data in the retrieved data and the data in the refined label data subset. As discussed below, similarity values may also be implemented in other determinations or applications of thresholds to determine data for extraction to a training dataset. Additionally, as discussed above, measures of similarity may also include relative measures of similarity (such as, but not limited to, agnostic rankings of similarity) for determination of data for extraction to a training dataset.

As one (simple) example for a ranking based on similarity values determined for additional data, a data point (e.g., item of data) may be selected from the refined label data subset and the selected data called “Data_A”. Similar to an example above, Data_A may include text, “TextA”, having a given label, “Label-I”. Thus, textual similarity values for the data in the received additional data will be determined against the text, “TextA”, in Data_A. As described above, textual similarity values are numerical indications of the similarity between text associated with two data points. For this example, the additional data retrieved based on the label, “Label-I” includes eight items of data—“Data_XA”, “Data_XB”, “Data_XC”, “Data_XD”, “Data_XE”. “Data_XF”, “Data_XG”, and “Data_XH”. As these eight items of data have been retrieved based on having the same label, the only difference between the retrieved items of data and the original item of data, Data_A, is the data itself (e.g., the text data). Accordingly, a similarity algorithm may be applied to the eight additional items of data to determine textual similarity values between the items of data in the retrieved additional data and the item of data in the refined label data subset for the given label, “Label-I”. TABLE II provides an example of textual similarity values between Data_A and the eight items of data retrieved based on Label-I (with 0 being no similarity and 1 being substantially similar or identical).

TABLE II

| Data Item | Textual Similarity Value to Data_A |
|---|---|
| Data_XA | 0.854 |
| Data_XB | 0.732 |
| Data_XC | 0.134 |
| Data_XD | 0.903 |
| Data_XE | 0.455 |
| Data_XF | 0.689 |
| Data_XG | 0.555 |
| Data_XH | 0.711 |

With the determined textual similarity values, a ranking of textual similarity (e.g., data similarity) for the items of data would be (from highest to lowest similarity): Data_XD, Data_XA, Data_XB, Data_XH, Data_XF, Data_XG, Data_XE, Data_XC. An agnostic ranking may just list the data sets based on their ranking (e.g., the output would just be a list of the sets of data from highest similarity to lowest similarity without any actual similarity values provided).

Similar rankings of the retrieved additional data may be determined for each set of data associated with each label implemented in the retrieval of additional data (e.g., for every label present in both the refined label data subset and the retrieved data). For example, if the refined label data subset includes three different labels implemented in the retrieval of additional data-Label-I (from above and associated with Data_A from the refined label data subset) along with “Label-II” (associated with Data_B from the refined label data subset), and “Label-III” (associated with Data_C from the refined label data subset)—then there would be three sets of retrieved additional data, each with its own similarity values/rankings to the data corresponding to the label associated with the retrieved data. For instance, in addition to the data retrieved for Label-I and Data_A, a second retrieved set of additional data for Label-II and Data_B includes eight items of data—Data_YA, Data_YB, Data_YC, Data_YD, Data_YE, Data_YF, Data_YG, Data_YH. These eight items of data would all have the label—Label-II—as they were retrieved based on that label for Data_B. A third retrieved set of additional data for Label-III and Data_C includes eight items of data—Data_ZA, Data_ZB, Data_ZC, Data_ZD, Data_ZE, Data_ZF, Data_ZG, Data_ZH. These eight items of data would all have the label—Label-III—as they were retrieved based on that label for Data_C. Similar to the data retrieved in association with Data_A, textual similarity values can be determined for each item of data in the second and third retrieved sets of additional data. TABLE III is an example showing textual similarity values determined between Data_B and the eight items of data retrieved based on Label-II—Data_YA, Data_YB, Data_YC, Data_YD, Data_YE, Data_YF, Data_YG, Data_YH.

TABLE III

| Data Item | Textual Similarity Value to Data_B |
|---|---|
| Data_YA | 0.312 |
| Data_YB | 0.966 |
| Data_YC | 0.913 |
| Data_YD | 0.446 |
| Data_YE | 0.512 |
| Data_YF | 0.051 |
| Data_YG | 0.379 |
| Data_YH | 0.642 |

With the determined textual similarity values to Data_B, a ranking of textual similarity (e.g., data similarity) for these items of data would be (from highest to lowest similarity): Data_YB, Data_YC, Data_YH, Data_YE, Data_YD, Data_YG, Data_YA, Data_YF. TABLE IV is an example showing textual similarity values determined between Data_C and the eight items of data retrieved based on Label-III—Data_ZA, Data_ZB, Data_ZC, Data_ZD, Data_ZE, Data_ZF, Data_ZG, Data_ZH.

TABLE IV

| Data Item | Textual Similarity Value to Data_C |
|---|---|
| Data_ZA | 0.654 |
| Data_ZB | 0.224 |
| Data_ZC | 0.378 |
| Data_ZD | 0.114 |
| Data_ZE | 0.953 |
| Data_ZF | 0.912 |
| Data_ZG | 0.144 |
| Data_ZH | 0.491 |

With the determined textual similarity values to Data_C, a ranking of textual similarity (e.g., data similarity) for these items of data would be (from highest to lowest similarity): Data_ZE, Data_ZF, Data_ZA, Data_ZH, Data_ZC, Data_ZB, Data_ZG, Data_ZD.

In various embodiments, the retrieved additional data and their corresponding similarity values/rankings (or, in some embodiments, agnostic rankings) determined by data similarity determination module 320 is provided to data extraction module 330. Data extraction module 330 may determine the data to extract (e.g., select) from the retrieved additional data for the training dataset based on the similarity values/rankings (or agnostic rankings). In certain embodiments, data extraction module 330 determines the data to extract for the training dataset by implementing one or more predetermined thresholds on the additional data and corresponding measures of similarity (e.g., similarity values/rankings).

In some embodiments, a predetermined threshold may be applied to the rankings of similarity to select x number of data based on their similarity rankings. Application of such a predetermined threshold (e.g., a predetermined ranking threshold) may select a number of nearest neighbors that satisfy the predetermined ranking threshold (based on the similarity rankings). For example, if the predetermined threshold is to select two data points (e.g., two items of data with x=2), then the two nearest neighbors based on the ranking of similarity satisfy the predetermined ranking threshold and are going to be selected. In the case of the similarity values and rankings for the data sets in TABLES II, III, and IV, if the predetermined threshold is to select two data points (e.g., items of data)(x=2) then Data_XD and Data_XA would be selected for extraction to the training dataset due to their being the two most similar to Data_A. Further, Data_YB and Data_YC would be selected for extraction to the training dataset due to their being the two most similar to Data_B while Data_ZE and Data_ZF would be selected for extraction to the training dataset due to their being the two most similar to Data_C. Meanwhile, the remaining items of data in each set of retrieved data would not be selected for any extraction to the training dataset since these items of data are not in the top two rankings of similarity values corresponding to their label and the item of data in the refined label data subset associated with their label. Based on the x=2 threshold, these six items of data (Data_XD, Data_XA, Data_YB, Data_YC, Data_ZE, and Data_ZF) would be selected and added to the refined label data subset for generation of a training dataset. The resulting training dataset would thus include a total nine items of data—Data_A, Data_B. Data_C, Data_XD, Data_XA, Data_YB, Data_YC, Data_ZE, and Data_ZF—with three items of data being from the refined label data subset and six items from the retrieved additional data.

While the above-described predetermined threshold is a criteria for x number of datasets based on similarity ranking, it should be understood that various criteria as well as various combinations of criteria may be implemented for predetermined thresholds that can be applied to determine the retrieved additional data to be extracted for the training dataset. For instance, one criterion for a predetermined threshold could be a minimum similarity value such that any piece of data with a similarity value above the minimum similarity value is selected for the training dataset. For example, using the data of TABLES II, III, and IV above, the predetermined threshold could be a minimum similarity value of 0.900 such that only Data_XD would be selected for extraction to the training dataset based on similarity to Data_A while both Data_YB and Data_YC, would still be selected for extraction to the training dataset based on similarity to Data_B and Data_ZE and Data_ZF would still be selected for extraction to the training dataset based on similarity to Data_C.

As an example of a combination of criteria, a predetermined threshold could be based on a combination of ranking and minimum similarity value. For instance, a predetermined threshold could include x=3 for ranking with a minimum similarity value of 0.900. Accordingly, while the x=3 ranking selects Data_XA, Data_XB, and Data_XD for the training dataset for similarity to Data_A, only Data_XD would be extracted for the training dataset as both Data_XA and Data_XB do not meet the minimum similarity value threshold. Similarly, while the x=3 ranking selects Data_YB, Data_YC, and Data_YH for the training dataset for similarity to Data_B. Data_YH would not be extracted for the training dataset as it does not meet the minimum similarity value threshold.

One example of another statistical criteria that can be implemented for the predetermine threshold is a percentage of datasets based on ranking. For instance, a predetermined threshold could be set to select the highest ranked 25% of available sets of retrieved additional data for extraction to the training dataset. Thus, the 25% of total available datasets with the highest similarity rankings would be selected for extraction to the training dataset. Similar to the ranking predetermined threshold, the percentage of datasets threshold could be applied in combination with another criteria such as a minimum similarity value (e.g., 25% of available sets of retrieved additional data with minimum similarity value of 0.900).

In various embodiments, the predetermined thresholds for selection of retrieved additional data extracted for the training dataset are varied to either select more data or get higher quality data. For instance, the predetermined thresholds may be lowered if the desired result is to have more data in the training dataset. In contrast, the predetermined thresholds may be raised if the desired result is to have higher quality data in the training dataset (e.g., data within tight similarity constraints to the data subset with refined labels). Accordingly, the boundaries for the predetermined thresholds may be adjusted to balance the needs for performance of the machine learning algorithm being trained according to the training dataset depending on whether more data is needed for training or higher quality data (e.g., more accurately labelled data) is needed for training. It should also be understood that the same predetermined threshold does not need to be applied to every piece of data in the data subset with refined labels. For instance, different items of data in the refined label data subset may have different predetermined thresholds (e.g., Data_A may have a different predetermined threshold from Data_B).

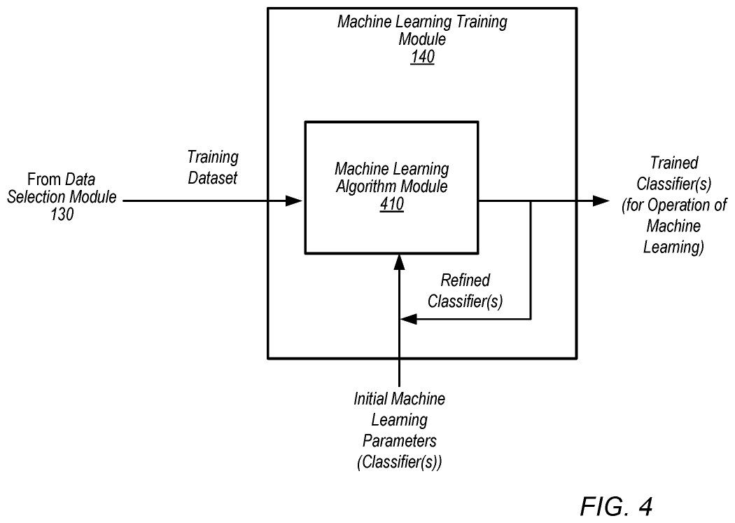

As shown in FIG. 3, the retrieved additional data selected for extraction may be combined with the refined label data subset and output by data extraction module 330 as a training dataset. Turning back to FIG. 1, machine learning training module 140 receives the training dataset from data selection module 130. Using the training dataset, machine learning training module 140 may generate one or more trained classifiers according to training methods known in the art. FIG. 4 is a block diagram of machine learning training module 140, according to some embodiments. In the illustrated embodiment, machine learning training module 140 includes machine learning algorithm module 410. Machine learning algorithm module 410 may generate predictions through classification of input data. In certain embodiments, machine learning algorithm module 410 implements classification of text data. For instance, in one embodiment, machine learning algorithm module 410 may implement classification of text data to make predictions on intent of utterances (e.g., words or phrases) in the text. The text data may be, for example, text obtained from customer service chats or voice-to-text data from audio customer service chats.

In certain embodiments, machine learning algorithm module 410 receives the training dataset from data selection module 130 and tunes (e.g., refines) itself to generate one or more trained classifiers for classifying text data. In some embodiments, machine learning algorithm module 410 begins its training by implementing one or more predetermined classifiers that are part of initial machine learning parameters provided to the machine learning algorithm module 410. These initial machine learning parameters may be starting points for refinement of the classifier(s) implemented by machine learning algorithm module 410.

In various embodiments, machine learning algorithm module 410 may implement various steps of encoding, embedding, and applying functions to fine tune (e.g., “train”) itself and refine its classifier(s) to provide accurate predictions of categories for the text data with probabilistic labels that have been input into the machine learning algorithm module 410. After one or more refinements of the classifier(s), the one or more trained classifiers may be output (e.g., accessed) from machine learning algorithm module 410. These trained classifiers may then be implemented by machine learning algorithm module 410 or another machine learning algorithm (such as a machine learning algorithm implemented on another computing system) to classify text data.

In various embodiments, machine learning algorithm module 410 may undergo verification of the training (e.g., determination of accuracy of the machine learning algorithm output) or evaluation of the performance of the machine learning algorithm module 410 after training. When either verification or evaluation fails to meet certain thresholds, machine learning algorithm module 410 may be determined to need additional training. In some embodiments, the additional training includes modification of the training dataset. In such embodiments, additional processing on the training dataset may be implemented by system 100. During the additional processing, the predetermined thresholds may be adjusted to either increase the data in the training dataset or to increase the quality of data in the training dataset, as discussed above.

As described herein, the training dataset provided to machine learning training module 140 may be a high-quality, large scale dataset. The training dataset is high-quality (e.g., has a high accuracy in labelling) since the dataset includes data that has with labelling that has been refined based on annotation (e.g., human annotation) and application of historical information. After refinement of the labelling, additional data is extracted to increase the scale of the dataset where the additional data is extracted based on similarity to the high-quality data and, yet further, extracted based on existing labels for the extracted data matching labels in the refined label data to reduce the likelihood of errors in the labels on the extracted data. The extraction of the additional data based on similarity to the high-quality data may be done without additional human input (e.g., there is no human input after the generation of the high-quality data). Accordingly, system 100, shown in FIG. 1 and further described with respect to FIGS. 2 and 3, is a system capable of producing large scale training datasets that have high accuracy in labelling with minimal human input over a short time frame (e.g., a few hours in some instances). Thus, the time and costs needed to create high-quality, large scale training datasets are reduced by the implementation of system 100 and its related process. Additionally, the training datasets generated by system 100 may amplify the signal in an original dataset (e.g., the dataset in database module 150) while reducing noise in the original dataset. The training datasets generated by system 100 may also include hundreds of classification categories without significantly increasing development time for the training datasets due to the automated extraction capability once a refined dataset is developed. For instance, multiple sets of training data may be generated for each category from a single dataset for each category over a short period of time by implementing the automatic extraction and labelling capability of system 100.

In various embodiments, the process for generating a training dataset by extraction of data from database module 150 by data selection module 130 may be implemented to update training datasets. For example, in one embodiment as described above, the training dataset may be updated when verification or performance evaluation of the training of machine learning algorithm module 410 fails to satisfy specified verification or performance thresholds. Other instances where updating the training dataset may be implemented include, but are not limited to, when there is data drift during operation of an existing machine learning algorithm or when new categories have been added to data for classification by the existing machine learning algorithm. Data drift may include, for example, a change in performance that causes performance by the existing machine learning algorithm (e.g., machine learning algorithm module 410). New categories may be added when new data or new strategies for data analysis become available. For example, in the instance of intent classification, a new category may be added to categorize a new intent that has been identified as useful for determining improved customer service.

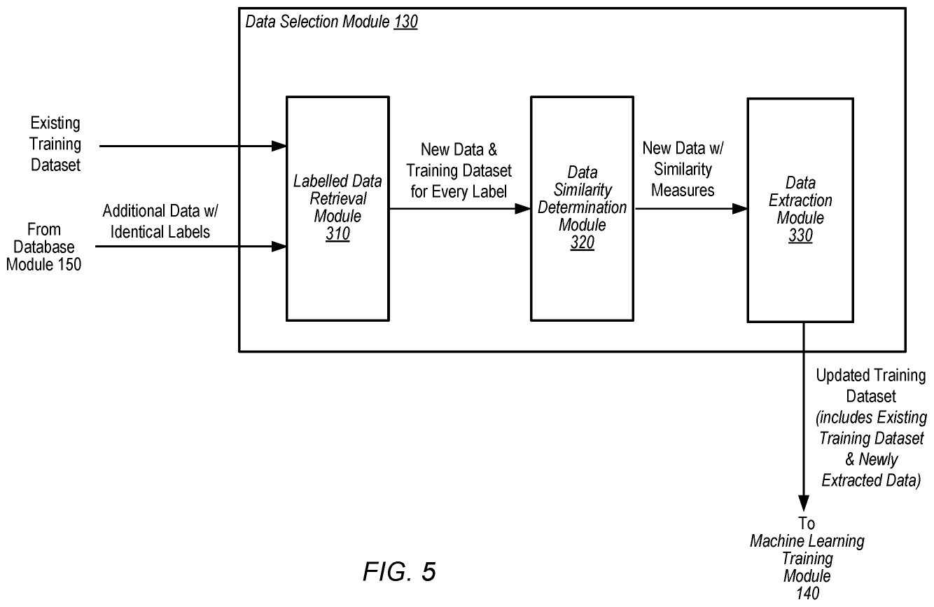

Since the existing training dataset has previously been determined by system 100, updates to the training dataset may be implemented without any further human input by applying the existing training dataset directly to data selection module 130. FIG. 5 is a block diagram of data selection module 130 implemented on an existing training dataset, according to some embodiments. In various embodiments, data selection module 130 may access the existing training dataset (which may be stored in a database module somewhere in system 100 or in a system accessible by system 100) in response to some indication that the training dataset needs to be updated. For instance, as described above, the indication may be that there is data drift in the machine learning algorithm, there is new data available, or a new data category has been implemented.

In the illustrated embodiment, data selection module 130 includes labelled data retrieval module 310, data similarity determination module 320, and data extraction module 330, as previously shown in FIG. 3. In various embodiments, as shown in FIG. 5, labelled data retrieval module 310 retrieves additional data with identical labels to the labels found in the existing training dataset. For example, labelled data retrieval module 310 may receive the existing training dataset and identify the labels found in the existing training dataset. From the identification of the labels found in the existing training dataset, labelled data retrieval module 310 may then access (e.g., retrieve) additional data having the same (e.g., identical) labels from database module 150. Thus, labelled data retrieval module 310 retrieves an additional set of data for a given label found in the existing training dataset based on the data in the additional set having the same given label.

After labelled data retrieval module 310 retrieves the additional data based on identical labels, the retrieved additional data along with the existing training dataset is provided to data similarity determination module 320. In certain embodiments, data similarity determination module 320 determines, for each set of data associated with each label implemented in the retrieval of additional data, measures of similarity between the data (e.g., text data) in the retrieved data and the data in the existing training dataset. In various embodiments, data similarity determination module 320 determines similarity values between the newly accessed additional data and the data in the existing training dataset. Similarity values may be determined as described above with respect to the embodiments associated with FIG. 3. After the similarity values (or rankings) are determined by data similarity determination module 320, data extraction module 330 may utilize the similarity values to determine the newly extracted data to update the training dataset. For instance, as described above, data extraction module 330 may determine the data to extract for the training dataset based on the similarity values/rankings by implementing one or more predetermined thresholds on the newly accessed additional data and the corresponding similarity values/rankings for the newly accessed additional data.

In certain embodiments, the newly extracted data may be combined with the existing training dataset and provided as an “updated” training dataset to machine learning training module 140 by data extraction module 330. As the existing training dataset is updated by data selection module 130 without the need for annotation or other human input, the training dataset may be considered to be automatically updated. Additionally, the automatic updating of the existing training dataset may be implemented on a relatively short time frame, which may be even shorter than the time frame needed to create a new training dataset in system 100. With the updated training dataset, machine learning training module 140 may then retrain the machine learning algorithm, which may include updating or replacement of the previously determined trained classifiers implemented by the machine learning algorithm.

### Example Methods

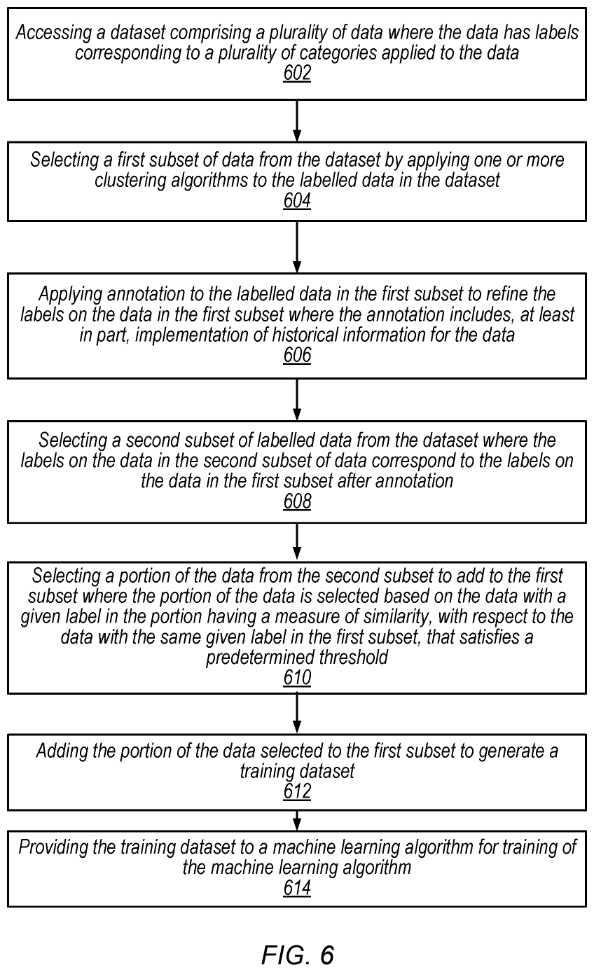

FIG. 6 is a flow diagram illustrating a method for generating a training dataset for a machine learning algorithm, according to some embodiments. The method shown in FIG. 6 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system, such as computing device 810, described below.

At 602, in the illustrated embodiment, a computer system accesses a dataset comprising a plurality of data where the data has labels corresponding to a plurality of categories applied to the data.

At 604, in the illustrated embodiment, the computer system selects a first subset of data from the dataset by applying one or more clustering algorithms to the labelled data in the dataset.

At 606, in the illustrated embodiment, the computer system applies annotation to the labelled data in the first subset to refine the labels on the data in the first subset where the annotation includes, at least in part, implementation of historical information for the data.

At 608, in the illustrated embodiment, the computer system selects a second subset of labelled data from the dataset where the labels on the data in the second subset of data correspond to the labels on the data in the first subset after annotation.

At 610, in the illustrated embodiment, the computer system selects a portion of the data from the second subset to add to the first subset where the portion of the data is selected based on the data with a given label in the portion having a measure of similarity, with respect to the data with the same given label in the first subset, that satisfies a predetermined threshold.

At 612, in the illustrated embodiment, the computer system adds the portion of the data selected to the first subset to generate a training dataset.

At 614, in the illustrated embodiment, the computer system provides the training dataset to a machine learning algorithm for training of the machine learning algorithm.

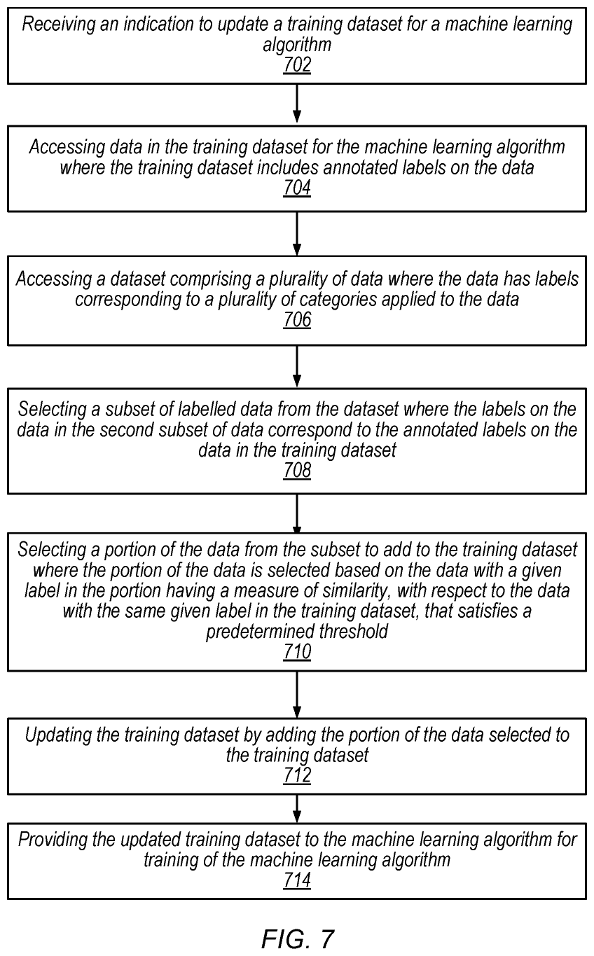

FIG. 7 is a flow diagram illustrating a method for updating a training dataset for a machine learning algorithm, according to some embodiments. The method shown in FIG. 7 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system, such as computing device 810, described below.

At 702, in the illustrated embodiment, a computer system receives an indication to update a training dataset for a machine learning algorithm.

At 704, in the illustrated embodiment, the computer system accesses data in the training dataset for the machine learning algorithm where the training dataset includes annotated labels on the data.

At 706, in the illustrated embodiment, the computer system accesses a dataset comprising a plurality of data where the data has labels corresponding to a plurality of categories applied to the data.

At 708, in the illustrated embodiment, the computer system selects a subset of labelled data from the dataset where the labels on the data in the second subset of data correspond to the annotated labels on the data in the training dataset.

At 710, in the illustrated embodiment, the computer system selects a portion of the data from the subset to add to the training dataset where the portion of the data is selected based on the data with a given label in the portion having a measure of similarity, with respect to the data with the same given label in the training dataset, that satisfies a predetermined threshold.

At 712, in the illustrated embodiment, the computer system updates the training dataset by adding the portion of the data selected to the training dataset.

At 714, in the illustrated embodiment, the computer system provides the updated training dataset to the machine learning algorithm for training of the machine learning algorithm.

### Example Computer System

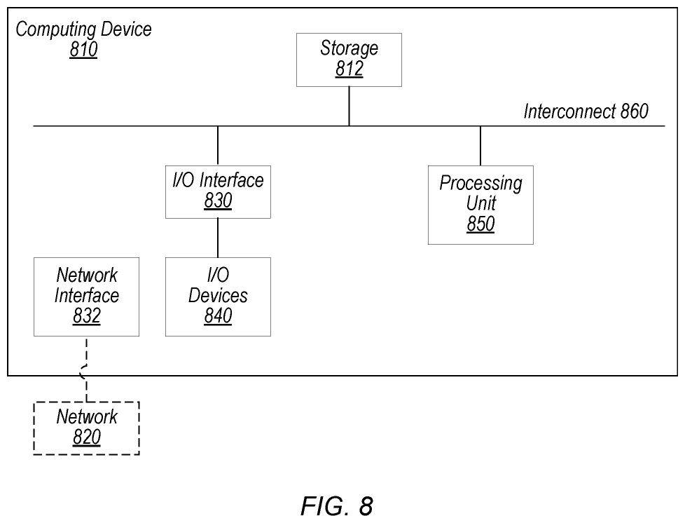

Turning now to FIG. 8, a block diagram of one embodiment of computing device (which may also be referred to as a computing system) 810 is depicted. Computing device 810 may be used to implement various portions of this disclosure. Computing device 810 may be any suitable type of device, including, but not limited to, a personal computer system, desktop computer, laptop or notebook computer, mainframe computer system, web server, workstation, or network computer. As shown, computing device 810 includes processing unit 850, storage 812, and input/output (I/O) interface 830 coupled via an interconnect 860 (e.g., a system bus). I/O interface 830 may be coupled to one or more I/O devices 840. Computing device 810 further includes network interface 832, which may be coupled to network 820 for communications with, for example, other computing devices.

In various embodiments, processing unit 850 includes one or more processors. In some embodiments, processing unit 850 includes one or more coprocessor units. In some embodiments, multiple instances of processing unit 850 may be coupled to interconnect 860. Processing unit 850 (or each processor within 850) may contain a cache or other form of on-board memory. In some embodiments, processing unit 850 may be implemented as a general-purpose processing unit, and in other embodiments it may be implemented as a special purpose processing unit (e.g., an ASIC). In general, computing device 810 is not limited to any particular type of processing unit or processor subsystem.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Storage 812 is usable by processing unit 850 (e.g., to store instructions executable by and data used by processing unit 850). Storage 812 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage 812 may consist solely of volatile memory, in one embodiment. Storage 812 may store program instructions executable by computing device 810 using processing unit 850, including program instructions executable to cause computing device 810 to implement the various techniques disclosed herein.

I/O interface 830 may represent one or more interfaces and may be any of various types of interfaces configured to couple to and communicate with other devices, according to various embodiments. In one embodiment, I/O interface 830 is a bridge chip from a front-side to one or more back-side buses. I/O interface 830 may be coupled to one or more I/O devices 840 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
accessing, by a computer system, a dataset comprising a plurality of data, wherein the data is labelled corresponding to a plurality of categories;
selecting a first subset of data from the dataset by applying one or more clustering algorithms to the labelled data in the dataset;
applying annotation to the labelled data in the first subset to refine the labels on the data in the first subset, wherein the annotation includes, at least in part,
implementation of historical information for the data;
selecting a second subset of labelled data from the dataset, wherein the labels on the data in the second subset of data correspond to the labels on the data in the first subset after annotation;
selecting a portion of the data from the second subset to add to the first subset, wherein the portion of the data is selected based on the data with a given label in the portion having a measure of similarity, with respect to the data with the same given label in the first subset, that satisfies a predetermined threshold;
adding the portion of the data selected to the first subset to generate a training dataset; and
providing the training dataset to a machine learning algorithm for training of the machine learning algorithm.

2. The method of claim 1, wherein the data with the given label in the portion having the measure of similarity satisfying the predetermined threshold indicates that the data in the portion with the given label has a nearest neighbor ranking for similarity, to the data with the same given label in the first subset, that satisfies a predetermined ranking threshold.

3. The method of claim 1, wherein selecting the portion of the data to add to the first subset includes:
determining, for the given label, similarity values between the data with the given label in the second subset and the data with the given label in the first subset; and
determining data from the second subset to include in the portion of the data based on the data with the given label in the second subset having a similarity value that satisfies the predetermined threshold.

4. The method of claim 1, wherein selecting the portion of the data to add to the first subset includes:
determining, for the given label, a ranking of similarity between the data with the given label in the second subset and the data with the given label in the first subset; and
determining data from the second subset to include in the portion of the data based on the ranking of similarity for the data with the given label in the second subset satisfying the predetermined threshold, wherein the predetermined threshold is a threshold for the ranking of similarity.

5. The method of claim 1, wherein selecting the portion of the data to add to the first subset includes:
determining, for every individual label present in both the first subset and the second subset, a ranking of similarity between the data with an individual label in the second subset and the data with the individual label in the first subset; and
determining, for every individual label present in both the first subset and the second subset, data from the second subset to include in the portion of the data, wherein the data to be included is determined based on the ranking of similarity for the data with the individual label in the second subset satisfying the predetermined threshold, the predetermined threshold being a threshold for the ranking of similarity.

6. The method of claim 1, wherein the second subset of labelled data is selected from the dataset by determining additional data from the dataset that has labels that are identical to the labels on the data in the first subset after annotation.

7. The method of claim 1, wherein applying the annotation to the labelled data includes determining an agreement in the labels on the data in the first subset after implementation of the historical information for the data.

8. The method of claim 1, further comprising applying a cleanup algorithm to the first subset after annotation, wherein the cleanup algorithm includes:
determining a set of nearest neighbors to a given item of data in the first subset based on data in the given item of data and data in the nearest neighbors, wherein the set of nearest neighbors includes a set of nearest items of data based on similarities between the data in the nearest neighbors and the data in the given item of data;
determining a number of nearest neighbors in the set of nearest neighbors that have labels identical to a label on the data in the given item of data;
retaining the given item of data in the first subset when the number of nearest neighbors that have identical labels satisfies a predetermined threshold for a minimum number of nearest neighbors having the same label; and
removing the given item of data from the first subset when the number of nearest neighbors that have identical labels fails to satisfy the predetermined threshold for the minimum number of nearest neighbors having the same label.

9. The method of claim 1, wherein the plurality of data in the dataset includes text data, and wherein at least one of the categories applied to the data is an intent category.

10. The method of claim 1, wherein at least one item of data in the first subset is labelled with a mislabeled category, and wherein applying the annotation to the first subset corrects the mislabeled category.

11. A method, comprising:
receiving, by a computer system, an indication to update a training dataset for a machine learning algorithm;
accessing, by the computer system in response to the indication, data in the training dataset for the machine learning algorithm, wherein the training dataset includes annotated labels on the data;
accessing, by the computer system, a dataset comprising a plurality of data, wherein the data is labelled corresponding to a plurality of categories;
selecting a subset of labelled data from the dataset, wherein the labels on the data in the subset of data correspond to the annotated labels on the data in the training dataset;
selecting a portion of the data from the subset to add to the training dataset, wherein the portion of the data is selected based on the data with a given label in the portion having a measure of similarity, with respect to the data with the same given label in the training dataset, that satisfies a predetermined threshold;
updating the training dataset by adding the portion of the data selected to the training dataset; and
providing the updated training dataset to the machine learning algorithm for training of the machine learning algorithm.

12. The method of claim 11, wherein the indication to update the training dataset is received in response to a drift in performance of the machine learning algorithm being detected.

13. The method of claim 11, wherein the indication to update the training dataset is received in response to a new category being added to the dataset comprising the plurality of data.

14. The method of claim 11, wherein the indication to update the training dataset is received in response to additional data being added to the dataset comprising the plurality of data.

15. The method of claim 11, wherein selecting the portion of the data to add to the training dataset includes:
determining, for every individual label present in both the training dataset and the subset, similarity values between items of data with an individual label in the subset and an item of data with the individual label in the training dataset;
ranking, for every individual label, the items of data with the individual label in the subset based on the determined similarity values; and
selecting, for every individual label, a set of items of data with the individual label to add to the training dataset based on the ranking of the set of items of data with the individual label in the subset satisfying a predetermined threshold for ranking of similarity to the item of data with the individual label in the training dataset.

16. The method of claim 15, wherein at least some of the annotated labels in the training dataset have been applied, at least in part, by human-based annotation with implementation of historical information.

17. A non-transitory computer-readable medium having instructions stored thereon that are executable by a computing device to perform operations, comprising:
accessing a dataset comprising a plurality of data, wherein the data is labelled corresponding to a plurality of categories;
selecting a first subset of data from the dataset by applying one or more clustering algorithms to the labelled data in the dataset;
applying annotation to the labelled data in the first subset to refine the labels on the data in the first subset, wherein the annotation includes, at least in part,
implementation of historical information for the data;
selecting a second subset of labelled data from the dataset, wherein the labels on the data in the second subset of data correspond to the labels on the data in the first subset after annotation;
selecting at least one item of data with a given label from the second subset to add to the first subset, wherein the at least one item of data with the given label is selected based on the at least one item of data with the given label having a ranking of similarity, with respect to the data with the same given label in the first subset, that satisfies a predetermined threshold; and
adding the at least one item of data with the given label to the first subset to generate a training dataset for a machine learning algorithm.

18. The computer-readable medium of claim 17, further comprising:
selecting at least one additional item of data with the given label from the second subset to add to the first subset, wherein the at least one additional item of data with the given label is selected based on the at least one additional item of data with the given label having a ranking of similarity, with respect to the data with the same given label in the first subset, that satisfies the predetermined threshold; and
adding the at least one additional item of data with the given label to the generated training dataset for the machine learning algorithm.

19. The computer-readable medium of claim 18, wherein the at least one additional item of data is selected in response to training of the machine learning algorithm failing to be verified.

20. The computer-readable medium of claim 17, further comprising implementing the training dataset in training of the machine learning algorithm to determine one or more trained classifiers for the machine learning algorithm.
